(19) United States
(12) Patent Application Publication
(10) Pub. No.: US 2026/0180360 A1
(43) Pub. Date: Jun. 25, 2026

(54) OPTIMIZING BATTERY CHARGING PROFILES TO REDUCE IMPACT OF GREENHOUSE GAS FOOTPRINT

(71) Applicant: DELL PRODUCTS L.P., Round Rock, TX (US)

(72) Inventors: Andrew T. Sultenfuss, Leander, TX (US); Balasingh P. Samuel, Round Rock, TX (US); Vivek Viswanathan Iyer, Saint Johns, FL (US)

(21) Appl. No.: 18/988,598

(22) Filed: Dec. 19, 2024

(51) Int. Cl. H02J 13/00

(52) U.S. Cl. CPC H02J 13/12

(57) ABSTRACT

An information handling system collects telemetry data, and collects greenhouse gas emission data from a power grid that powers the information handling system. The information handling system generates a workload execution heatmap associated with a user of the information handling system, wherein the workload execution heatmap is based on the telemetry data. In addition, the system generates a battery charging profile based on the workload execution heatmap and greenhouse gas emission data from the power grid and configures a battery plugin based on the battery charging profile.

### FIELD OF THE DISCLOSURE

The present disclosure generally relates to information handling systems, and more particularly relates to optimizing battery charging profiles to reduce the impact of greenhouse gas footprints.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system is configured to collect telemetry data, and to collect greenhouse gas emission data from a power grid that provides energy to the information handling system. The information handling system is also configured to generate a workload execution heatmap associated with a user of the information handling system, wherein the workload execution heatmap is based on the telemetry data. In addition, the information handling system is configured to generate a battery charging profile based on the workload execution heatmap and greenhouse gas emission data from the power grid and configure a battery plugin based on the battery charging profile.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a system for optimizing a battery charging profile to reduce the impact of greenhouse gas footprint, according to an embodiment of the present disclosure;

FIG. 2 is a sequence diagram of a method for optimizing a battery charging profile to reduce impact of greenhouse gas footprint, according to an embodiment of the present disclosure;

FIG. 3 is a diagram of a heatmap associated with workload execution of an information handling system, according to an embodiment of the present disclosure;

FIG. 4 is a diagram of a heatmap associated with power source type of an information handling system, according to an embodiment of the present disclosure;

FIG. 5 is a diagram of a greenhouse gas emission map, according to an embodiment of the present disclosure;

FIG. 6 is a diagram of recommendations for optimizing a battery charging profile to reduce the impact of greenhouse gas footprint, according to an embodiment of the present disclosure;

FIG. 7 is a diagram of a greenhouse gas configuration for optimizing a battery charging profile to reduce the impact of a greenhouse gas footprint, according to an embodiment of the present disclosure; and

FIG. 8 is a diagram of an information handling system, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

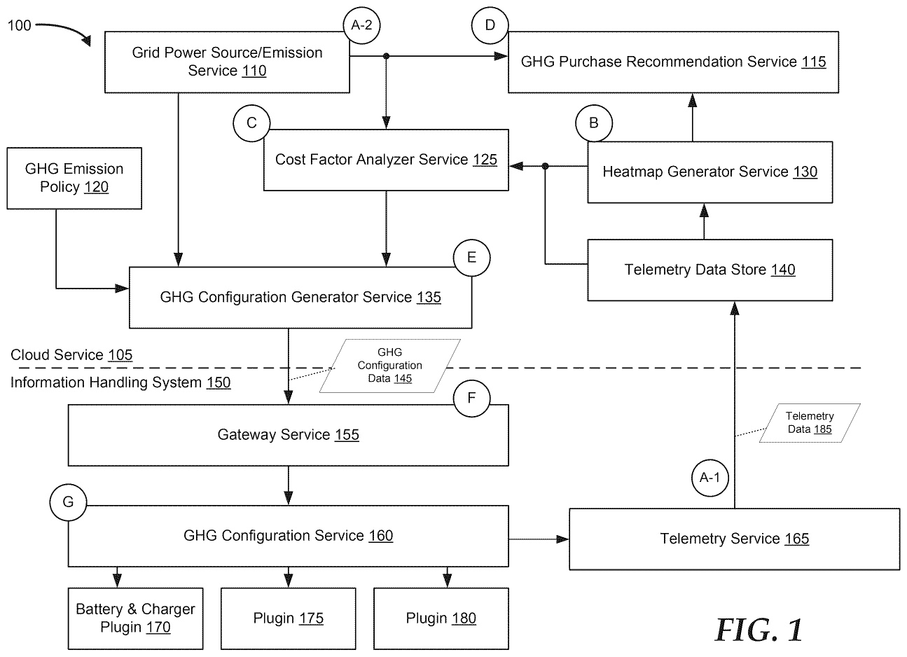

FIG. 1 illustrates a portion of a system 100 for optimizing a battery charging profile to reduce the impact of a greenhouse gas footprint, according to an embodiment of the present disclosure. The greenhouse gas (GHG) emissions protocol is a global standard used to measure and manage GHG emissions from private and public sector operations. Consumers are placing an ever-increasing value on minimizing GHG emissions generated during use of a product is projected to sway a consumer's purchasing decision to an increasing degree over the years. One impact on GHG emissions includes the consumption of power at end devices, such as an information handling system. While purchasing an information handling system, customers can choose different configurations that can affect the power consumption and GHG emissions of the information handling system in addition to its cost and governmental ratings. Helping the customer isolate the best solution from a myriad of options is elusive at best and challenging in general. Because the power consumption of an end device is affected by choice of a battery and power adapter, helping customers choose the battery and power adapter for optimal GHG emission impact can be valuable. In addition, the present disclosure provides a system and method for optimizing a battery charging profile to reduce impact of GHG footprint when in use.

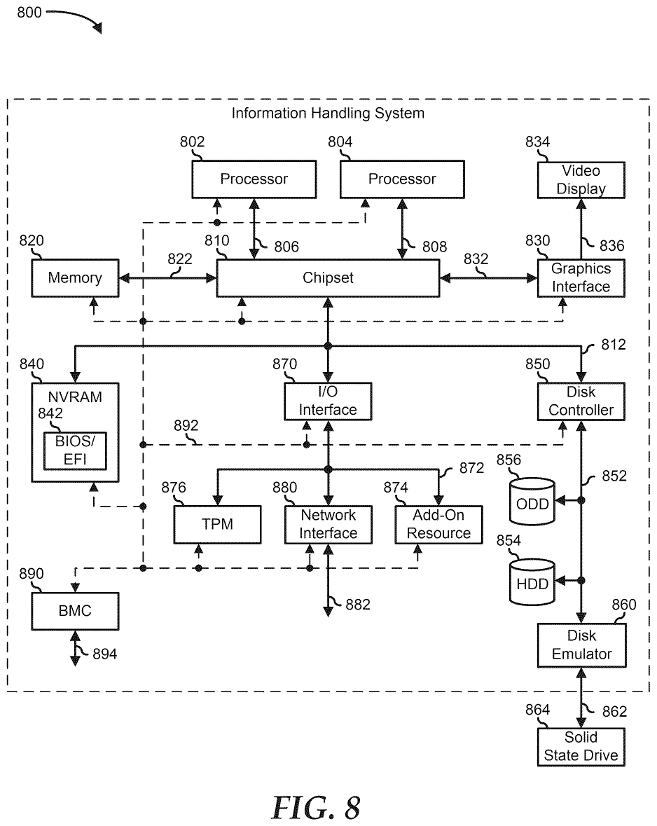

System 100 includes a cloud service 105 and an information handling system 150, which is similar to information handling system 800 of FIG. 8. Cloud service 105 includes a grid power source/emission service 110, a GHG purchase recommendation service 115, a GHG emission policy 120, a cost factor analyzer service 125, a heatmap generator service 130, a GHG configuration generator service 135, and a telemetry data store 140. Information handling system 150 includes a gateway service 155, a GHG configuration service 160, a telemetry service 165, a battery and charger plugin 170, a plugin 175, and a plugin 180.

Grid power source/emission service 110 may be communicatively coupled to GHG purchase recommendation service 115, cost factor analyzer service 125, and GHG configuration generator service 135. Cost factor analyzer service 125 may be communicatively coupled grid power source/emission service 110, GHG purchase recommendation service 115, heatmap generator service 130, GHG configuration generator service 135, and telemetry data store 140. Gateway service 155 is communicatively coupled to GHG configuration service 160, which is communicatively coupled to telemetry service 165, battery and charger plugin 170, plugin 175, and plugin 180. However, any variety of connections between the components of cloud service 105 and information handling system 150 is envisioned as falling within the scope of the present disclosure. In addition, connections between the components may be omitted for descriptive clarity. One of ordinary skill in the art will appreciate that although one information handling system is shown communicatively coupled to cloud service 105, more than one information handling system can be communicatively coupled to cloud service 105.

Cloud service 105 may include any system, device, or apparatus configured to provide one or more services to one or more computing devices, such as information handling system 150. Cloud service 105 may be communicatively coupled with the computing devices over a network. The network may use any one or more of a variety of networks or another type of communication connection as known to those skilled in the art. The type of communication connection used may vary with certain system parameters and requirements. The communication connection may be a network connection, bus, and/or another type of data link, such as a hardwire connection, a network cable, wireless or Wi-Fi® protocols, or other connections known in the art.

The network may be implemented as or maybe a part of, a personal area network, a local area network (LAN), a metropolitan area network, a wide area network, a wireless LAN (WLAN), a virtual private network, an intranet, the Internet, or any other appropriate architecture or system that facilitates the communication of signals, data and/or messages. In addition, the network may transmit data using any communication protocol, including without limitation, Fibre Channel, Frame Relay, Asynchronous Transfer Mode, Internet Protocol, or other packet-based protocol. Further, the network and its various components may be implemented using hardware, software, or any combination thereof. These components may be configured to facilitate communication between cloud service and various computing devices, such as information handling system 150.

Grid power source/emission service 110 may comprise any system, device, or apparatus configured to read, collect, and/or receive power grid emission data and/or GHG emission factors from a data access portal by a provider, power distributor, and/or power grid operator via an application programming interface (API). The power grid emission data and/or GHG emission factors may be used by GHG configuration generator service 135 to generate one or more recommendations, such as a battery and alternating current (AC) power adapter recommendation and a battery charging profile. The power grid emission data and/or GHG emission factors may indicate peak GHG emission periods, mid-GHG emission periods, and low GHG emission periods, among others.

GHG purchase recommendation service 115 may comprise any system, device, or apparatus configured to analyze data from grid power source/emission service 110 and heatmap generator service 130. The data may include information from one or more heatmaps, peak GHG emission periods, mid-GHG emission periods, low GHG emission periods, specification, and configuration of information handling system 150, etc. The data may also include telemetry data from telemetry data store 140. The heatmaps may include a “day in the life workload execution” heatmap and a “day in the life power type” heatmap. The peak GHG emission periods, mid-GHG emission periods, and low GHG emission periods may be based on power grid emission data and/or GHG emission factors. The specification and configuration of information handling system 150 may be based on the telemetry data.

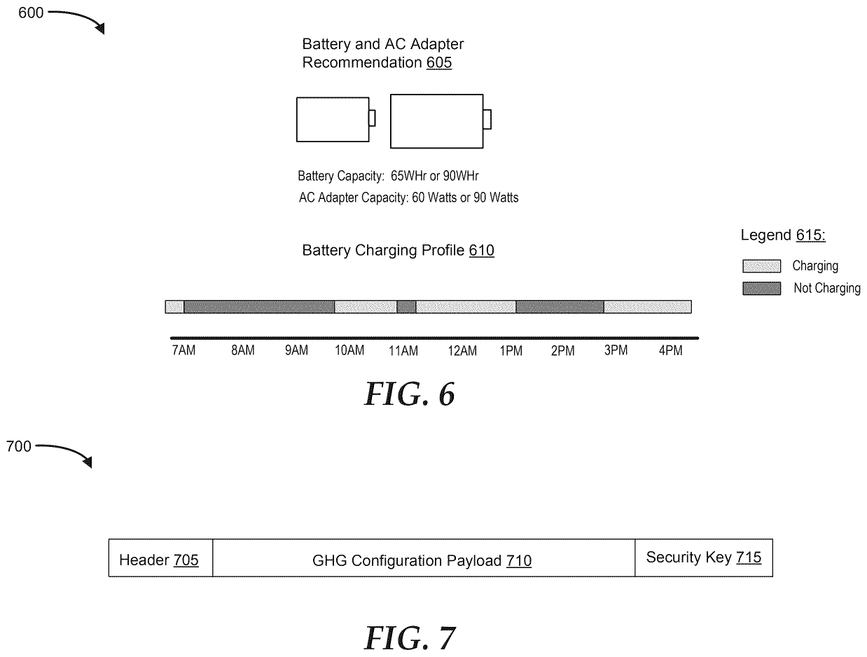

Based on the data, GHG purchase recommendation service 115 may provide a battery and AC adapter recommendation, such as depicted in FIG. 6. For example, GHG purchase recommendation service 115 may recommend a battery with a capacity of 90-watt hours (Wh) over a 65 Wh battery. Accordingly, GHG purchase recommendation service 115 may recommend an AC adapter with a capacity of 90 watts in line with the recommended battery. GHG purchase recommendation service 115 may transmit information associated with the recommendation to cost factor analyzer service 125. GHG purchase recommendation service 115 may also be configured to provide other recommendations, such as size of a display monitor and/or type of motherboard for the information handling system.

Cost factor analyzer service 125 may comprise any system, device, or apparatus that is configured to estimate cost to operate an information handling system, such as information handling system 150 according to one or more heatmaps, such as the “day in the life workload execution map” and “day in the life power type” heatmaps. Cost factor analyzer service 125 may also calculate the cost based on data provided by the power grid, such as the GHG emissions, and GHG emission factor, among other data. For example, cost factor analyzer service 125 may identify and analyze factors that affect the workload execution, cost of charging the battery, cost of using the AC power outlet, cost of operating a display monitor, etc.

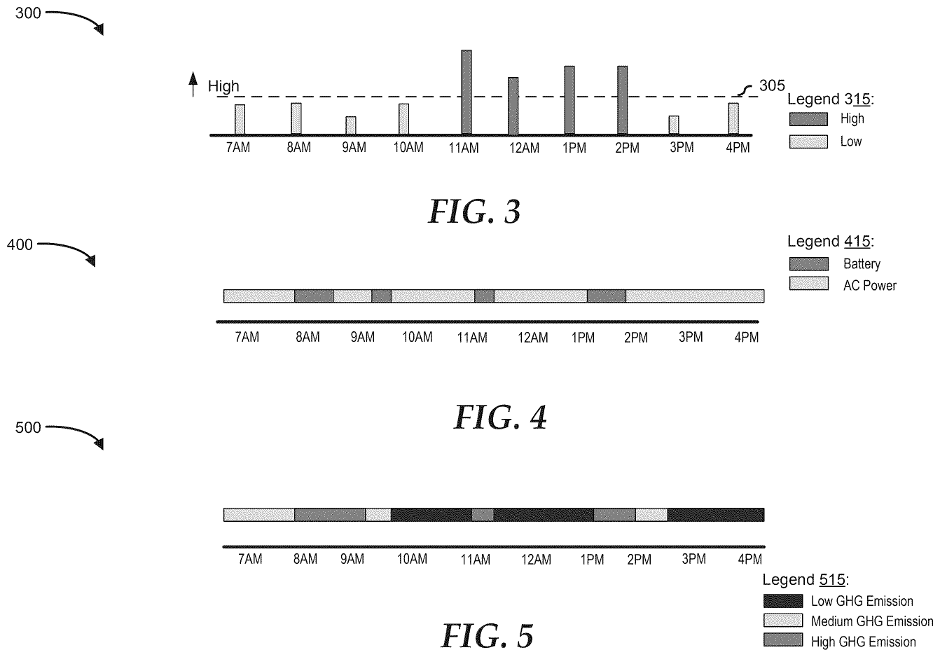

Heatmap generator service 130 may comprise any system, device, or apparatus that is configured to generate one or more heatmaps based on the telemetry data from telemetry data store 140, etc. For example, heatmap generator service 130 may generate a “day in the life workload execution” heatmap similar to a heatmap 300 in FIG. 3. Heatmap generator service 130 may also generate heatmaps similar to a heatmap 400 of FIG. 4 and heatmap 500 in FIG. 5. Heatmap generator service 130 may generate the heatmaps using different techniques, including gradient-based techniques and perturbation-based techniques.

GHG configuration generator service 135 may comprise any device or apparatus that is configured to generate a battery charging profile, similar to a battery charging profile 610 of FIG. 6, for one or more information handling systems. Each battery charging profile may be unique for each information handling system. In addition, if there are two or more users of the information handling system, then GHG configuration generator service 135 may generate a unique battery charging profile for each one of the users.

Although power consumption at an information handling system in an embodiment may not directly generate GHGs, such power consumption may be associated indirectly with GHG emissions. For example, power consumed by an information handling system may be drawn from a power plant burning fossil fuels or other non-renewable resources instead of renewable resources. The adaptive battery charging profile, similar to a battery charging profile 610 of FIG. 6 may determine when GHG emission is higher and initiate battery usage instead of consuming power from an AC power outlet. Accordingly, the battery charging profile may determine when the GHG emission is lower and initiate consuming power from the AC power outlet. In addition, at this point, the battery charging profile may initiate charging the battery of the information handling system based on the battery charging profile.

Telemetry data store 140 may comprise any device or apparatus that is configured to store telemetry data from one or more telemetry services, such as telemetry service 165. Telemetry data store 140 may be based on one or more data platforms such as relational databases, HADOOP™, etc. The telemetry data may also be stored in various formats such as text files, extensible markup language (XML) files, comma-separated values (CSV) files, etc. Telemetry data store 140 may be in a persistent storage device such as a solid-state disk, hard disk drive, magnetic tape library, optical disk drive, magneto-optical disk drive, compact disk drive, compact disk array, disk array controller, and/or any computer-readable medium operable to store data.

GHG emission policy 120 may include one or more rules associated with battery charging management of an information handling system. The rules may be satisfied in the alternative, in conjunction with, or by applying a more complex logical test. In some embodiments, a battery charging management policy may include temporal specifications to indicate when the policy should be enforced. In one embodiment, the battery charging management policy may include one or more enabling or disabling trigger events, such as based on a battery charging profile. GHG emission policy 120 may be used by GHG configuration service 160 to manage and/or align power sources by time, duration, location, estimated cost, etc. via generating one or more recommendations, such as the battery charging profile.

Gateway service 155 may comprise any system, device, or apparatus that is configured to allow communication between information handling system 150 and cloud service 105. Gateway service 155 may be a background process, such as a Unix® daemon or a Windows® service. Gateway service 155 may be configured to receive data from one or more cloud services, such as GHG configuration generator service 135 of cloud service 105.

GHG configuration service 160 may comprise any system, device, or apparatus that is configured to collect and/or receive GHG configuration data from GHG configuration generator service 135 via gateway service 155. In addition, GHG configuration service 160 may be configured to program one or more configuration settings of an embedded controller based on the GHG configuration data, which is similar to GHG configuration 700 of FIG. 7. The embedded controller may then program one or more configuration settings of battery and charger plugin 170. The embedded controller may also program the configuration settings of plugin 175 and plugin 180 based on the received GHG configuration data.

Telemetry service 165 may include any system, device, or apparatus configured to collect or receive telemetry data, such as platform, system usage, and context data from various sources or components of information handling system 150. The telemetry data may also include battery charge rate, performance data, total system power, number and types of applications used, latency, time on the grid, time off the grid, etc. Telemetry service 165 may collect or receive the telemetry data periodically, such as every second, minute, hour, etc., or a fraction thereof. Telemetry service 165 may transmit the telemetry data for storage at telemetry data store 140.

Information handling system 150 may include a battery and battery and charger plugin 170. The battery may include a Lithium-ion or Li-ion rechargeable device capable of storing energy sufficient to power information handling system 150 for an amount of time, depending on the information handling system's workload, environmental condition, etc. Battery and charger plugin 170 may be configured to manage the battery and the battery's charging/discharging operations, among others, such as by applying or implementing the battery charging profile. For example, battery and charger plugin 170 may charge the battery according to a battery charging profile, such as the one depicted in FIG. 6. The battery and charger plugin 170 may also use the battery to power information handling system 150 based on the battery charging profile. The battery charging profile may include a charging plan for the battery to maximize the GHG and performance goal of information handling system 150 and/or the battery in association with the battery's characterization and other factors such as the model, capacity, and other information associated with an AC adapter associated with the battery. Accordingly, battery and charger plugin 170 may be configured to interface with the battery and the AC adapter.

One of ordinary skill in the art will appreciate that plugins 175 and 180 may represent plugins for other components or devices, wherein GHG configuration data can be provided and utilized. In one example, plugin 175 may be a display device plugin which may be configured to adapt a display device profile. The display device profile may be used in managing power provided to a display device to optimize its GHG emission. In another example, plugin 180 may be associated with another device or component of information handling system 150. For example, plugin 180 may be a power supply management plugin which may be configured to adapt a power supply profile. Similarly, the power supply profile may be utilized in managing the power provided to the information handling system to optimize the information handling system's GHG emission.

FIG. 1 is annotated with a series of letters from A-1 through G. Each of these letters represents a stage of one or more operations. Although these stages are ordered for this example, the stages illustrate one example to aid in understanding this disclosure and should not be used to limit the claims. Subject matter falling within the scope of the claims can vary with respect to the order of the operations.

At stage A-1, telemetry service 165 may receive and/or collect telemetry data associated with one or more components of information handling system 150. Telemetry service 165 may transmit the telemetry data, such as telemetry data 185, to telemetry data store 140 for storage. At stage A-2, grid power source/emission service 110 may receive or collect power data, such as power grid emission data and/or GHG emission factors from a power grid, power distributor, government site, etc.

At stage B, heatmap generator service 130 may generate one or more heatmaps based on at least telemetry data 185. For example, heatmap generator service 130 may generate a “day in the life workload execution” heatmap and a “day in the life power type” heatmap. At stage C, cost factor analyzer service 125 may estimate the cost to operate the computer. The cost may be estimated for each time period based on the “day in the life workload execution” heatmap, a “day in the life power type” heatmap, power grid emission data, GHG emission factors, etc. The length of the time period may be determined by a policy, such as GHG emission policy 120. For example, the cost may be determined for each work hour. The cost determined may be monetary cost or environmental cost based on GHG emission. The calculated cost may be used in determining recommendations, such as battery and AC adapter recommendation and battery charging profile.

At stage D, GHG purchase recommendation service 115 may generate a battery capacity recommendation and an AC adapter recommendation for a user. The recommendation may be based on how long the battery has to power the information handling system between charging. A battery with a higher capacity can provide power longer than a battery with a lower capacity. The user may be an end user or an information technology decision maker (ITDM) who manages more than one information handling system. At stage E, GHG configuration generator service 135 may generate a battery charging profile based on a GHG value and/or cost, according to policy, such as GHG emission policy 120. For example, if the environmental cost is higher when utilizing an AC outlet to power the information handling system during the peak GHG emission period, then GHG configuration generator service 135 may recommend using the battery to power the information handling system during this period.

At stage F, GHG configuration generator service 135 may transmit GHG configuration data, such as GHG configuration data 145 to information handling system 150 via gateway service 155. GHG configuration data 145 may include information associated with the battery charging profile generated by GHG configuration generator service 135.

At stage G, GHG configuration service 160 may receive GHG configuration data 145 and provide applicable payload with a GHG configuration setting for each plugin, such as battery and charger plugin 170, via an embedded controller. Battery and charger plugin may update one or more configuration settings based on the received data.

Those of ordinary skill in the art will appreciate that the configuration, hardware, and/or software components of system 100 depicted in FIG. 1 may vary. For example, the illustrative components within system 100 are not intended to be exhaustive, but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

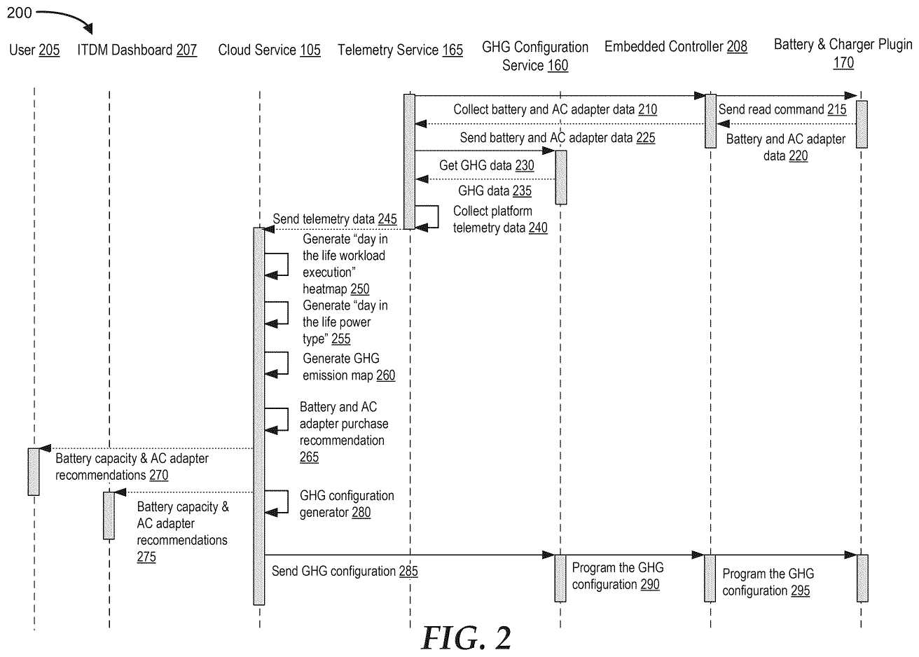

FIG. 2 shows a method 200 for optimizing the battery charging profile to reduce impact of greenhouse gas footprint. Operations depicted in method 200 may include operations performed by any suitable component of system 100 of FIG. 1 including but not limited to cloud service 105, telemetry service 165, GHG configuration service 160, and battery and charger plugin 170. Results of the operations may be provided to a user 205 and/or an ITDM dashboard 207. While embodiments of the present disclosure are described in terms of the components of system 100 of FIG. 1, it should be recognized that other components may be utilized to perform the described operations. It will be readily appreciated that not every operation set forth in this sequence diagram is always necessary and that certain operations may be combined, performed simultaneously, in a different order, or perhaps omitted, without varying from the scope of the disclosure. One of skill in the art will appreciate that this sequence diagram explains a typical example, which can be extended to applications or services in practice. In addition, portions of method 200 may be performed periodically, such as every workday.

For example, a battery charging profile or a portion thereof may be generated every workday. Method 200 typically starts at operation 210 where telemetry service 165 may send a request to collect telemetry data, such as battery and AC adapter data to embedded controller 208. Embedded controller 208 may send a request to read or get the battery and AC adapter data to battery and charger plugin 170 at operation 215. Embedded controller 208 may also send a request to read telemetry data to other components of the information handling system. Battery and charger plugin 170 may send a response with battery and AC adapter data to embedded controller 208 at operation 220. Embedded controller 208 may send the received battery and AC adapter data to telemetry service 165 at operation 225. Embedded controller 208 may also transmit other telemetry data received to telemetry service 165.

At operation 230, telemetry service 165 may send a request to read or get GHG-specific data to GHG configuration service 160. GHG configuration service 160 may respond with the requested GHG data to the telemetry service at operation 235. At operation 240, telemetry service 165 may collect and/or receive platform telemetry data associated with the information handling system from various sources or components of the information handling system. Platform telemetry data includes logs, metrics, events, and traces created by applications and/or processes. For example, telemetry service 165 may collect data indicative of the type and number of applications that user 205 runs at particular times, performance of one or more processes, latency, transactions per second, errors generated by an application, CPU and memory usage, disk input/output, etc. The platform telemetry data to be collected may be pre-determined by an ITDM of the information handling system.

At operation 245 telemetry service 165 may send the telemetry data to cloud service 105 which includes battery and AC adapter data and platform telemetry data. Telemetry service 165 may also transmit other data as configured. For example, telemetry service 165 may store the telemetry data at telemetry data store 140 of FIG. 1. Cloud service 105 may generate one or more heatmaps and provide recommendations, such as battery capacity recommendation, AC adapter type recommendation, and battery charging profile based on one or more of the platform telemetry data, GHG specific data, and/or battery and AC adapter data, among others. At operation 250, cloud service 105 may generate a “data in the life workload execution” heatmap, such as one depicted in FIG. 3. At operation 255, cloud service 105 may generate a “day in the life power type” heatmap, such as one depicted in FIG. 4. At operation 260, cloud service 105 may generate a GHG emission map, such as one depicted in FIG. 5.

At operation 265, cloud service 105 may generate a battery capacity and AC adapter recommendation that is similar to battery capacity and AC adapter recommendation 605 of FIG. 6. The battery capacity and AC adapter recommendation may be based on the length of a typical workday of a user, GHG emission, and/or GHG cost factor, among others. The GHG emissions map, such as heatmap 400 of FIG. 4 may indicate the level of GHG emissions per time period according to the user's typical workday which is from 7:00 AM to 4:00 PM. In this example, the power grid data indicates high GHG emissions impact at around 8:00 AM, 11:00 AM, and 1:00 PM. This may indicate, based on the power grid data, that there is high fossil fuel type consumption, such as greater than 90% around the aforementioned period which results in the high or peak GHG emissions. Further, the power grid data may indicate that there is a medium GHG emission around 7:00 AM and a low GHG emission around 10:00 AM. Based on this information, cloud service 105 may recommend a battery with high capacity and a corresponding adapter. This may allow the information handling system to run on battery power during the peak GHG emissions instead of utilizing AC power.

At operation 270, cloud service 105 may transmit the battery capacity and AC adapter recommendation to user 205, such as to a display device of the information handling system. At operation 275, cloud service 105 may transmit the battery capacity and the AC adapter recommendation to ITDM dashboard 207. At operation 280, cloud service 105 may generate a battery charging profile, similar to battery charging profile 610 of FIG. 6 which is configured for the information handling system. The recommendation may be based on various factors similar to above, such as the length of a typical workday of a user, GHG emission, and/or GHG cost factor, among others. The information handling system may be run on battery power based on the GHG emission and/or GHG cost factor. The recommendation may also optimize the timing of charging and discharging the battery for offsetting GHG emissions and/or costs by aligning the battery capacity and AC adapter recommendation with the battery charging profile. For example, because the power grid data may indicate a low GHG emission from around 10:00 AM to 11:00 AM, the battery may be charged at this time period. Similarly, at around 11:00 AM the power grid data indicate a peak GHG emission, the battery may be used to power the information handling system.

The battery capacity and AC adapter recommendation and battery charging profile may be reported to the user, wherein the user may be given the ability to update one or both of the recommendations. Accordingly, one or more of the recommendations may be adjusted based on feedback and/or updates from the user. For example, if the user rejects the battery capacity and AC adapter recommendation, then the battery charging profile may be updated automatically to reflect the change in the timing of the charging and discharging of the battery based on its different capacities.

While the recommendations provided herein are adapted to an information handling system's battery capacity and charging profile, one of ordinary skill in the art will appreciate that the analysis performed herein may be adapted to other components of the information handling system. For example, cloud service 105 may generate a recommendation for a display device associated with the information handling system. In a particular example, a recommendation for one larger display device with a flat screen instead of two display devices may be provided as this typically has lower GHG emissions. In addition, a power management profile for the display device may also be recommended. In a particular example, based on the power management profile, the display device may be automatically turned off outside of work hours or after a certain number of minutes when the user is not detected in front of the display device.

At operation 285, cloud service 105 may transmit the GHG configuration similar to GHG configuration 700 of FIG. 7 to GHG configuration service 160 of the information handling system. The GHG configuration may include data associated with the battery charging profile, among others. For example, the GHG configuration may also include data associated with other profiles generated. At operation 290, GHG configuration service 160 may program the GHG configuration to embedded controller 208. At operation 295, the embedded controller may program the GHG configuration to battery and charger plugin 170.

FIG. 3 shows a heatmap 300 that may represent a “day in the life workload execution” heatmap. Heatmap 300 indicates processor utilization, also referred to as CPU usage, per time period. In this example, heatmap 300 is presented as a bar chart that plots values for levels of processor utilization as bars. Processor utilization levels are plotted on a vertical axis, which is divided between low and high performance thresholds by a threshold 305. The length of each bar may correspond to a performance utilization value. For example, the processor utilization level below threshold 305 may be classified as low utilization while the processor utilization level above threshold 305 may be classified as high utilization.

Time periods are plotted on a horizontal axis. In this example, the horizontal axis is divided into hourly periods of a workday. The vertical and/or the horizontal axis can be represented according to a policy. As such, the vertical axis and/or the horizontal axis can be divided differently than the one shown. For example, instead of the horizontal axis being divided into work hours, the horizontal axis can be divided into workdays. In addition, although heatmap 300 is shown as a bar chart, one of ordinary skill in the art will appreciate that a heatmap may be represented differently, such as via a line graph, box plot, etc. A legend 315 may indicate whether the processor utilization is high or low.

FIG. 4 illustrates a portion of heatmap 400 that may represent a “day in the life power type” heatmap. Heatmap 400 indicates the power type used per time period. In this example, heatmap 400 is presented using a single horizontal bar that may be divided into time periods according to policy. In this example, the horizontal axis is divided into hourly periods of a workday. The horizontal axis can be divided differently than the one shown. For example, instead of the horizontal axis being divided into work hours, the horizontal axis can be divided into workdays. A color palette may be used to represent the data. For example, as indicated by a legend 415, a first color may indicate battery usage to power the information handling system while a second color may indicate using an AC outlet to power the information handling system.

FIG. 5 illustrates a portion of a heatmap 500 using power grid data, according to an embodiment of the present disclosure. A grid power source/emission service may be configured to read or collect GHG emission data and/or GHG emission factors from power grids or other entities. The GHG emission data and/or GHG emission factors may be collected and downloaded periodically. The updated GHG emission data and/or GHG emission factors provide visibility into changes throughout the workday and allow for a more accurate recommendation. GHG emission factors are coefficients that allow conversion of activity data into GHS emissions associated with the energy sources.

Heatmap 500 may represent GHG emission levels based on grid power source emissions and/or emission factors received or collected from grid power source providers by a local service running on an information handling system or a remote cloud service. The grid power source emission or emission cost factors may be collected passively in real time from grid power source providers. Data shown show how much GHG is generated over given periods. Characterized data from grid power source providers may be used when real-time data is unavailable. In addition, when the data cannot be collected from the power grid, the service may collect the data from other government or similar sites.

An energy grid typically uses one or a mix of energy sources that provide energy, such as electricity to data centers and information handling systems, among others. Examples of energy sources include non-renewable energy sources, wind energy sources, hydroelectric energy sources, nuclear energy sources, and solar energy sources. Each of the energy sources has an associated GHG emission. The mix of energy sources can be static or dynamic, changing throughout the day or a specific period. Accordingly, GHG emissions can vary from, such as from low to medium then to high.

Heatmap 500 may represent a GHG emission map that indicates a level of GHG emission per time period. In this example, heatmap 500 is presented using a single horizontal bar that may be divided into time periods according to policy. In this example, the horizontal axis is divided into hourly periods of a workday similar to heatmap 400. Accordingly, the horizontal axis can be divided differently than the one shown. A color palette may be used to represent the data. For example, as indicated by a legend 515, a first color may indicate a low GHG emission, a second color may indicate a mid-GHG emission, and a third color may indicate a high GHG emission.

In particular, heatmap 500 shows different GHG emission levels at various periods throughout the day. For example, from 7:00 AM to 8:00 AM, the GHG emission is medium while from 8:00 AM to 9:00 AM the GHG emission is high. Further, the GHG emission from 10:00 to 11:00 AM is low. Similar to above, one of ordinary skill in the art will appreciate that the heatmap 500 may be illustrated using other visualization tools.

FIG. 6 illustrates a portion of a recommendation provided by GHG purchase recommendation service 115 and GHG configuration generator service 135 of FIG. 1, according to an embodiment of the present disclosure. One impact of power grid GHG emissions is the consumption of power at end devices such as information handling systems operated by an end user. The power consumption of an end device is typically affected by the capacity of the battery, which is generally rated in watt-hours (WHr), such as 40 WHr, 60 WHr, and 90 WHr. In addition, batteries have other specifications, such as number of cells, milliampere-hour (mAh) rating, voltage, etc. which can confuse a customer when choosing a battery and corresponding power adapter. Further, choosing a default configuration is rarely optimal in reducing one's GHG impact.

GHG emission factor, also referred to simply as an emission factor, may estimate the rate or amount of GHG released into the atmosphere associated with an activity like usage of an information handling system that includes CPU usage and charging the battery, among others. The GHG emission factor may be determined daily or dynamically in real time based on the power grid data. The determined GHG emission factor may be used in determining a battery and power adapter recommendation that is geared towards effective GHG impact reduction, as depicted in battery and AC adapter recommendation 605. For example, selecting a battery with higher capacity can address reductions in GHG by storing more energy. In this particular example, a battery capacity recommendation for the user is to purchase a battery with either a 65 WHr or 90 WHr capacity. In line with this, an AC adapter recommendation is for the user to purchase an AC power adapter with a 60-watt or 90-watt capacity.

The recommendation may include a battery capacity and AC adapter recommendation. For example, the recommendation may be a 65 Wh battery or a 90 Wh battery. The recommendation may be based on the “day in the life workload” and the “day in the life power type” heatmaps, and GHG emission maps, among others. This allows for optimal runtime impact on GHG generation and/or cost reduction. Typically, the higher watt-hours battery will have a longer run time on the same information handling system with the same operating conditions. The recommendation may also include a battery charging profile plan to maximize the GHG and performance goal based on information associated with the information handling system's battery and AC adapter.

In this example, battery charging profile 610 may have been based on the “day in the life workload” heatmap, the “day in the life power type” heatmap, and the GHG emission map, among others. As depicted, the user's workday starts at 7:00 AM, wherein the information handling system is plugged into an AC outlet from around 7:00 AM until 8:00 AM. At around 8:00 AM, the information handling system may be using battery power as typically the battery may have been charging at night so when the workday starts at 7:00 AM the battery may be fully charged. The battery may also be charging when the information handling system is plugged in at the start of the workday. In addition, based on the GHG emission map, the GHG emission may be high from around. 8:00 AM to 9:00 AM. Accordingly, it is recommended to use the battery for power as reflected on battery charging profile 610, the information handling system may utilize battery power from 7:00 AM to 10:00 AM.

The battery charging profile 610 may consider data from the power grid with the least GHG emission and/or cost. For example, because a renewable power source is available from around 10:00 AM to 11:00, this can translate to a lower GHG emission and/or GHG emission factor, the information handling system may use AC power and charge the battery during this time. Correspondingly, when the GHG power emission is high from around 1:00 PM to 2:00 PM, the information handling system may automatically switch to battery power during this time when charged. In general, the information handling system can run longer on battery and charged when the GHG emission and/or costs are both reduced and discharged or utilized when the GHG emission and/or costs are both higher. For those needing to work during times of peak demand and high GHG, a larger battery may be recommended. This helps minimize the cost for the user. This may also assist the power grid as there is less consumption during higher GHG emissions. A legend 615 may indicate whether the processor utilization is high or low.

FIG. 7 illustrates a portion of GHG configuration 700, according to an embodiment of the present disclosure. GHG configuration 700 includes a header 705, a GHG configuration payload 710, and a security key 715. Header 705 may describe information in GHG configuration payload 710. The information can include the length of GHG configuration payload 710, payload integrity check, encoding applied for transport if any, etc. GHG configuration payload 710 may include data associated with GHG configuration related to battery and AC adapter recommendation 605 and battery charging profile 610 of FIG. 6. For example, GHG configuration payload 710 may include battery charge start time, battery charge stop time, battery charge mode, power mode, etc. Security key 715 may be used to authenticate GHG configuration payload 710. For example, security key 715 may be a public key that can be used to verify the signature of GHG configuration payload 710.

FIG. 8 illustrates an embodiment of an information handling system 800 including processors 802 and 804, a chipset 810, a memory 820, a graphics adapter 830 connected to a video display 834, a non-volatile RAM (NVRAM) 840 that includes a basic input and output system/extensible firmware interface (BIOS/EFI) module 842, a disk controller 850, a hard disk drive (HDD) 854, an optical disk drive 856, a disk emulator 860 connected to a solid-state drive (SSD) 864, an input/output (I/O) interface 870 connected to an add-on resource 874 and a trusted platform module (TPM) 876, a network interface 880, and a baseboard management controller (BMC) 890. Processor 802 is connected to chipset 810 via processor interface 806, and processor 804 is connected to the chipset via processor interface 808. In a particular embodiment, processors 802 and 804 are connected together via a high-capacity coherent fabric, such as a HyperTransport link, a QuickPath Interconnect, or the like. Chipset 810 represents an integrated circuit or group of integrated circuits that manage the data flow between processors 802 and 804 and the other elements of information handling system 800. In a particular embodiment, chipset 810 represents a pair of integrated circuits, such as a northbridge component and a southbridge component. In another embodiment, some or all of the functions and features of chipset 810 are integrated with one or more of processors 802 and 804.

Memory 820 is connected to chipset 810 via a memory interface 822. An example of memory interface 822 includes a Double Data Rate (DDR) memory channel and memory 820 represents one or more DDR Dual In-Line Memory Modules (DIMMs). In a particular embodiment, memory interface 822 represents two or more DDR channels. In another embodiment, one or more of processors 802 and 804 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 820 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 830 is connected to chipset 810 via a graphics interface 832 and provides a video display output 836 to a video display 834. An example of a graphics interface 832 includes a Peripheral Component Interconnect-Express (PCIe) interface and graphics adapter 830 can include a four-lane (×4) PCIe adapter, an eight-lane (×8) PCIe adapter, a 16-lane (×16) PCIe adapter, or another configuration, as needed or desired. In a particular embodiment, graphics adapter 830 is provided down on a system printed circuit board (PCB). Video display output 836 can include a Digital Video Interface (DVI), a High-Definition Multimedia Interface (HDMI), a DisplayPort interface, or the like, and video display 834 can include a monitor, a smart television, an embedded display such as a laptop computer display, or the like.

NVRAM 840, disk controller 850, and I/O interface 870 are connected to chipset 810 via an I/O channel 812. An example of I/O channel 812 includes one or more point-to-point PCIe links between chipset 810 and each of NVRAM 840, disk controller 850, and I/O interface 870. Chipset 810 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface, a Universal Serial Bus (USB), another interface, or a combination thereof. NVRAM 840 includes BIOS/EFI module 842 that stores machine-executable code (BIOS/EFI code) that operates to detect the resources of information handling system 800, to provide drivers for the resources, to initialize the resources, and to provide common access mechanisms for the resources. The functions and features of BIOS/EFI module 842 will be further described below.

Disk controller 850 includes a disk interface 852 that connects the disc controller to a hard disk drive (HDD) 854, to an optical disk drive (ODD) 856, and to disk emulator 860. An example of disk interface 852 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 860 permits SSD 864 to be connected to information handling system 800 via an external interface 862. An example of external interface 862 includes a USB interface, an institute of electrical and electronics engineers (IEEE) 1394 (Firewire) interface, a proprietary interface, or a combination thereof. Alternatively, SSD 864 can be disposed within information handling system 800.

I/O interface 870 includes a peripheral interface 872 that connects the I/O interface to add-on resource 874, to TPM 876, and to network interface 880. Peripheral interface 872 can be the same type of interface as I/O channel 812 or can be a different type of interface. As such, I/O interface 870 extends the capacity of I/O channel 812 when peripheral interface 872 and the I/O channel are of the same type, and the I/O interface translates information from a format suitable to the I/O channel to a format suitable to the peripheral interface 872 when they are of a different type. Add-on resource 874 can include a data storage system, an additional graphics interface, a network interface card (NIC), a sound/video processing card, another add-on resource, or a combination thereof. Add-on resource 874 can be on a main circuit board, on a separate circuit board, or add-in card disposed within information handling system 800, a device that is external to the information handling system, or a combination thereof.

Network interface 880 represents a network communication device disposed within information handling system 800, on a main circuit board of the information handling system, integrated onto another component such as chipset 810, in another suitable location, or a combination thereof. Network interface 880 includes a network channel 882 that provides an interface to devices that are external to information handling system 800. In a particular embodiment, network channel 882 is of a different type than peripheral interface 872 and network interface 880 translates information from a format suitable to the peripheral channel to a format suitable to external devices.

In a particular embodiment, network interface 880 includes a NIC or host bus adapter (HBA), and an example of network channel 882 includes an InfiniBand channel, a Fibre Channel, a Gigabit Ethernet channel, a proprietary channel architecture, or a combination thereof. In another embodiment, network interface 880 includes a wireless communication interface, and network channel 882 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 882 can be connected to an external network resource (not illustrated). The network resource can include another information handling system, a data storage system, another network, a grid management system, another suitable resource, or a combination thereof.

BMC 890 is connected to multiple elements of information handling system 800 via one or more management interface 892 to provide out of band monitoring, maintenance, and control of the elements of the information handling system. As such, BMC 890 represents a processing device different from processor 802 and processor 804, which provides various management functions for information handling system 800. For example, BMC 890 may be responsible for power management, cooling management, and the like. The term BMC is often used in the context of server systems, while in a consumer-level device, a BMC may be referred to as an embedded controller (EC). A BMC included at a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 890 can vary considerably based on the type of information handling system. BMC 890 can operate in accordance with an Intelligent Platform Management Interface (IPMI). Examples of BMC 890 include an Integrated Dell® Remote Access Controller (iDRAC).

Management interface 892 represents one or more out-of-band communication interfaces between BMC 890 and the elements of information handling system 800, and can include an Inter-Integrated Circuit (I²C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 800, that is apart from the execution of code by processors 802 and 804 and procedures that are implemented on the information handling system in response to the executed code.

BMC 890 operates to monitor and maintain system firmware, such as code stored in BIOS/EFI module 842, option ROMs for graphics adapter 830, disk controller 850, add-on resource 874, network interface 880, or other elements of information handling system 800, as needed or desired. In particular, BMC 890 includes a network interface 894 that can be connected to a remote management system to receive firmware updates, as needed or desired. Here, BMC 890 receives the firmware updates, stores the updates to a data storage device associated with the BMC, and transfers the firmware updates to the NVRAM of the device or system that is the subject of the firmware update, thereby replacing the currently operating firmware associated with the device or system, and reboots information handling system, whereupon the device or system utilizes the updated firmware image.

BMC 890 utilizes various protocols and APIs to direct and control the processes for monitoring and maintaining the system firmware. An example of a protocol or API for monitoring and maintaining the system firmware includes a graphical user interface (GUI) associated with BMC 890, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by an “F2” boot option, or another protocol or API, as needed or desired.

In a particular embodiment, BMC 890 is included on a main circuit board (such as a baseboard, a motherboard, or any combination thereof) of information handling system 800 or is integrated onto another element of the information handling system such as chipset 810, or another suitable element, as needed or desired. As such, BMC 890 can be part of an integrated circuit or a chipset within information handling system 800. An example of BMC 890 includes an iDRAC, or the like. BMC 890 may operate on a separate power plane from other resources in information handling system 800. Thus BMC 890 can communicate with the management system via network interface 894 while the resources of information handling system 800 are powered off. Here, information can be sent from the management system to BMC 890 and the information can be stored in a RAM or NVRAM associated with the BMC. Information stored in the RAM may be lost after power-down of the power plane for BMC 890, while information stored in the NVRAM may be saved through a power-down/power-up cycle of the power plane for the BMC.

Information handling system 800 can include additional components and additional busses, not shown for clarity. For example, information handling system 800 can include multiple processor cores, audio devices, and the like. While a particular arrangement of bus technologies and interconnections is illustrated for the purpose of an example, one of skill will appreciate that the techniques disclosed herein are applicable to other system architectures. Information handling system 800 can include multiple central processing units (CPUs) and redundant bus controllers. One or more components can be integrated together. Information handling system 800 can include additional buses and bus protocols, for example, I²C and the like. Additional components of information handling system 800 can include one or more storage devices that can store machine-executable code, one or more communications ports for communicating with external devices, and various input and output (I/O) devices, such as a keyboard, a mouse, and a video display.

For purposes of this disclosure, information handling system 800 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 800 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 800 can include processing resources for executing machine-executable code, such as processor 802, a programmable logic array (PLA), an embedded device such as a System-on-a-Chip (SoC), or other control logic hardware. Information handling system 800 can also include one or more computer-readable media for storing machine-executable code, such as software or data.

Although FIG. 2 shows example blocks of method 200 in some implementations, method 200 may include additional operations, blocks, fewer blocks, different blocks, or differently arranged blocks than those depicted in FIG. 2. Those skilled in the art will understand that the principles presented herein may be implemented in any suitably arranged processing system. Additionally, or alternatively, two or more of the blocks of method 200 may be performed in parallel. For example, operations 270 and 275 of method 200 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a non-transitory computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that causes a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
collecting, by an information handling system, telemetry data;
collecting greenhouse gas emission data from a power grid that provides energy to the information handling system;
generating a workload execution heatmap associated with the information handling system, wherein the workload execution heatmap is based on the telemetry data;
generating a battery charging profile based on the workload execution heatmap and the greenhouse gas emission data from the power grid; and
configuring a battery plugin based on the battery charging profile.

2. The method of claim 1, further comprising generating a power source type heatmap for the information handling system.

3. The method of claim 1, further comprising generating a greenhouse gas emission heatmap based on the greenhouse gas emission data.

4. The method of claim 1, further comprising configuring an embedded controller based on the battery charging profile.

5. The method of claim 1, further comprising charging a battery of the information handling system when greenhouse gas emission is low based on the battery charging profile.

6. The method of claim 1, further comprising using a battery to power the information handling system when greenhouse gas emission is high based on the battery charging profile.

7. The method of claim 1, further comprising generating a battery capacity recommendation based on the workload execution heatmap and the greenhouse gas emission data from the power grid.

8. An information handling system, comprising:
a processor; and
a memory coupled to the processor, the memory having program instructions stored thereon that upon execution cause the processor to:
collect telemetry data from the information handling system;
collect greenhouse gas emission data from a power grid that provides energy to the information handling system;
generate a workload execution heatmap associated with a user of the information handling system, wherein the workload execution heatmap is based on the telemetry data;
generate a battery charging profile based on the workload execution heatmap and the greenhouse gas emission data from the power grid; and
configure a battery plugin based on the battery charging profile.

9. The information handling system of claim 8, wherein the program instructions upon execution further cause the processor to generate a power source type heatmap for the information handling system.

10. The information handling system of claim 8, wherein the program instructions upon execution further cause the processor to generate a greenhouse gas emission heatmap based on the greenhouse gas emission data.

11. The information handling system of claim 8, wherein the program instructions upon execution further cause the processor to configure an embedded controller based on the battery charging profile.

12. The information handling system of claim 8, wherein the program instructions upon execution further cause the processor to charge a battery of the information handling system when greenhouse gas emission is low based on the battery charging profile.

13. The information handling system of claim 8, wherein the program instructions upon execution further cause the processor to using a battery for power when greenhouse gas emission is high based on the battery charging profile.

14. The information handling system of claim 8, wherein the program instructions upon execution further cause the processor to generate a battery capacity recommendation based on the workload execution heatmap and the greenhouse gas emission data from the power grid.

15. A non-transitory computer-readable medium to store instructions that are executable to perform operations comprising:
collecting telemetry data from an information handling system;
collecting greenhouse gas emission data from a power grid that provides energy to the information handling system;
generating a workload execution heatmap associated with a user of the information handling system, wherein the workload execution heatmap is based on the telemetry data;
generating a battery charging profile based on the workload execution heatmap and the greenhouse gas emission data from the power grid; and
configuring a battery plugin based on the battery charging profile.

16. The non-transitory computer-readable medium of claim 15, wherein the operations further comprise generating a power source type heatmap for the information handling system.

17. The non-transitory computer-readable medium of claim 15, wherein the operations further comprise generating a greenhouse gas emission heatmap based on the greenhouse gas emission data.

18. The non-transitory computer-readable medium of claim 15, wherein the operations further comprise configuring an embedded controller based on the battery charging profile.

19. The non-transitory computer-readable medium of claim 15, wherein the operations further comprise charging a battery of the information handling system when greenhouse gas emission is low based on the battery charging profile.

20. The non-transitory computer-readable medium of claim 15, wherein the operations further comprise generating a battery capacity recommendation based on the workload execution heatmap and the greenhouse gas emission data from the power grid.
